(19) United States
(12) Patent Application Publication
(10) Pub. No.: US 2011/0138929 A1
(43) Pub. Date: Jun. 16, 2011

(54) Kinetic Flow Meter

(75) Inventor: Alan M. Young, Los Gatos, CA (US)

(73) Assignee: MALEMA ENGINEERING CORPORATION, Boca Raton, FL (US)

(21) Appl. No.: 12/703,021

(22) Filed: Feb. 9, 2010

Related U.S. Application Data
(60) Provisional application No. 61/285,506, filed on Dec. 10, 2009.

(51) Int. Cl. G01F 1/34

(52) U.S. Cl. 73/861.42

(57) ABSTRACT

A fluid flow rate and density measuring apparatus is disclosed. The apparatus includes a section of cylindrical conduit, a flow sensor housing for allowing fluid to pass through the open ends of the sensor housing as fluid flows through the conduit, and an elongated cylindrically symmetric structure located within the housing with its longitudinal axis aligned along that of the housing thereby forcing fluid through the annular gap between the exterior of the elongated cylindrically symmetric structure and the interior wall of the sensor housing. The apparatus includes a one-piece construction that includes the housing and the cylindrically symmetric structure. The cylindrically symmetric structure has a length-to-diameter ratio of at least 3:1 and reduces a cross-section area of the conduit to between 20% and 50% of an open inlet area of the conduit.

### CROSS REFERENCE TO RELATED APPLICATIONS

This application claims the benefit of U.S. Provisional Application No. 61/285,506, “Kinetic Flow Meter” by Alan M. Young filed on Dec. 10, 2009, the content of which is hereby incorporated by reference in its entirety.

### BACKGROUND OF THE INVENTION

Devices are known for measuring fluid flow using both static and dynamic pressure measurements. Dynamic pressure is the component of fluid pressure that represents fluid kinetic energy (i.e., is responsive to fluid motion), while static pressure represents only hydrostatic effects. Dynamic pressure results from the force of a fluid impinging on a surface whereas hydrostatic pressure measures only static pressure. Hydrostatic pressure exists regardless of whether the fluid is flowing, whereas dynamic pressure exists only when fluid is flowing. Traditional differential pressure (“DP”) devices measure the hydrostatic pressure drop across a structure inserted into the flow stream specifically designed to produce a substantial pressure drop (e.g., an orifice plate) in order to measure flow rate. Hydrostatic pressure differentials measured are smaller than dynamic pressure signals resulting in very limited dynamic flow measurement range.

U.S. Pat. No. 6,865,957 (“the '957 patent”) teaches a mass flow measurement by subtracting two dynamic pressure measurements. With reference to FIG. 4 of the '957 patent, a first dynamic pressure measurement P₁ is obtained at the apex of a conically-shaped end-piece; a second dynamic pressure measurement P₂ is obtained at a different location (i.e., different radial location) from a pressure port located within the “cylindrical portion” of the body. According to the '957 patent, solely the difference between these two dynamic pressure signals determines fluid mass flow rate. For example, the '957 patent states at column 4, lines 29-31, “FIG. 5 is a schematic flow diagram depicting the process employed in determining mass flow with the device of the present invention” and FIG. 5 explicitly illustrates that P₁-P₂ determines mass flow. At col. 6, lines 51-54, “The difference between pressures P₁ and P₂ are then determined either manually or automatically and, through the use of tables or graphs determine the mass flow of fluid through device 10.”

### SUMMARY OF THE INVENTION

In accordance with the present invention, a fluid flow rate and density measuring apparatus (also called a kinetic flow meter) includes a section of cylindrical conduit comprising a measurement section or housing for the flow sensor. The flow sensor housing is fixedly attached to a conduit at its distal ends allowing fluid to pass through the open ends of the sensor housing as fluid flows through the conduit. An elongated, streamlined, cylindrically symmetric structure is located within the housing with its longitudinal axis aligned along that of the housing thereby forcing fluid through the annular gap between the exterior of the elongated cylindrically symmetric structure and the interior wall of the sensor housing. The elongated cylindrically symmetric structure is fixedly attached within the sensor housing by one or more supports. In one embodiment, the apparatus is a one-piece construction that includes the sensor housing, a post, two pressure passageways, and the elongated cylindrically symmetric structure. The elongated cylindrically symmetric structure is dimensioned appropriately to accommodate the interior dimensions of the housing and the particular nature of the fluids, flow rates and densities to be measured. In one embodiment, the cylindrically symmetric structure has a length-to-diameter ratio of at least 4:1, and comprises no less than about 50% nor more than about 80% of the sensor's open inlet area. The present invention can also be used to measure bi-directional air flows for purposes of pulmonary testing in which case the flow sensor is not attached to a conduit.

In addition to the above mentioned elements, the present invention also includes at least one dynamic pressure measurement, which may be obtained at a location anywhere along the length of the annular region between the elongated cylindrically symmetric structure and the interior wall of the cylindrical sensor housing. In one embodiment, a first dynamic pressure measurement is obtained from an upstream-facing pressure port and a second dynamic pressure measurement is obtained from an adjacent, but oppositely directed (i.e., downstream-facing) pressure port. Thus, two dynamic pressure signals may be obtained allowing their combination to simultaneously determine the fluid mass flow rate, volumetric flow rate and density of the fluid (if it is a gas) passing through the apparatus.

In another embodiment, a dynamic pressure measurement is obtained from an upstream-facing pressure port (or equivalently from a downstream-facing pressure port) within the annular space between the elongated cylindrically symmetric structure and the interior wall of the sensor housing. A second pressure measurement is obtained at the interior wall of the sensor housing to obtain a static pressure measurement. Combining the two pressure signals allows simultaneous determination of fluid mass flow rate, volumetric flow rate and density passing through the flow sensor. In one embodiment, the up-stream-facing pressure port comprises a slot spanning substantially the entire width of the annular gap. In another embodiment, the post (or “support”) which houses the two pressure measurements has a non-rectangular and non-circular cross-section with corners positioned to enhance the sensor's signal-to-noise ratio.

In yet another embodiment, the mass flow measurement method of the present invention can be applied to the devices described in U.S. Pat. No. 6,865,957 B1 to provide for an improved mass flow rate measurement independent fluid of density and, in addition, provide simultaneous determination of volumetric flow rate and gas density.

### BRIEF DESCRIPTION OF THE DRAWINGS

FIG. 1 is a schematic representation of sensor with dynamic pressure ports for P₁ and P₂ incorporated into a removable subassembly.

FIG. 2 is a schematic diagram illustrating the measurement method to determine fluid mass flow rate, volumetric flow rate and density.

FIG. 3 is a diagram that illustrates a sensor subassembly cross-section with pressure ports for dynamic pressures P₁ and P₂ incorporated therein, the entire sensor subassembly being comprised of one-piece.

FIG. 4 is a diagram comprising a cross-sectional isometric illustration of sensor subassembly depicted in FIG. 3.

FIG. 5 is a diagram comprising an isometric illustration of sensor subassembly illustrated in FIG. 4.

FIG. 6 is a diagram that illustrates a cross-sectional illustration of a completely assembled flowmeter incorporating the sensor subassembly depicted in FIG. 3.

FIGS. 7 and 8 are diagrams that respectively illustrate exploded and isometric views of the flowmeter assembly depicted in FIG. 6.

FIG. 9 is a diagram that illustrates a frontal-view of a sensor subassembly (viewed in the down-stream direction along its longitudinal axis) illustrating the vertical-slot of the upstream-facing dynamic pressure sensing port that responds to fluid dynamic pressure substantially over the entire width of the annular gap.

FIG. 10 is a diagram that illustrates a top cross-sectional view of the post (which contains pressure sensing passageways) modified to reduce signals resulting from vortices shed upstream of the downstream-facing pressure port.

FIG. 11 is a diagram that illustrates a vertical cross-sectional view of the post depicted in FIG. 10.

FIG. 12 is a diagram illustrating test data obtained from a sensor with 0.36-inch O.D. cylindrical structure contained within a housing of 0.5-inch I.D. tested on water over a nearly 50:1 flow rate range exhibiting a response substantially independent of fluid flow regime.

FIG. 13 includes two diagrams illustrating test results obtained with 0.36-inch O.D. cylindrical structure contained within a housing of 0.5-inch I.D. demonstrating substantial immunity to piping configuration and flow velocity profile non-uniformities.

### DETAILED DESCRIPTION

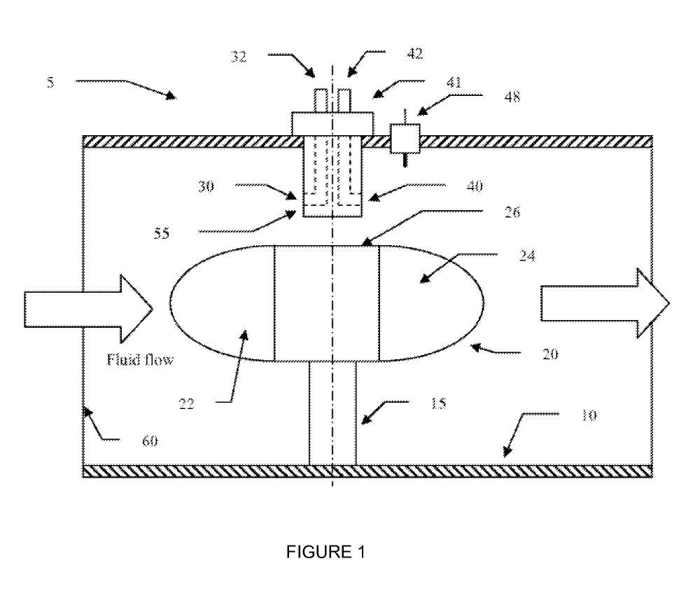

With reference to FIG. 1, a fluid flow rate and density measuring sensor 5 includes a tubular piece of conduit 10 comprising a measurement section or housing for the flow sensor. For industrial fluid flow measurement applications, the flow sensor housing is connected to a conduit allowing fluid to pass through the sensor. For pulmonary testing applications, a suitable mouthpiece connected to the sensor entrance would allow a patient to inhale/exhale air through the sensor. An elongated cylindrical structure 20 with streamline-shaped ends 22 and 24 is located within the housing with its longitudinal axis aligned along that of the housing thereby forcing fluid to flow through the annular region between the exterior of the elongated cylindrical structure and the interior wall of the sensor housing. The streamlined cylindrical structure 20 may not necessarily have a straight cylindrical segment 26 interposed respectively between the two ends 22 and 24. Additionally, the elongated cylindrical structure need not exhibit bilateral symmetry about its mid-point (e.g., the structure may be shaped differently at one distal end compared to the other and/or exhibit a variable cross-sectional shape and may be tapered along its length). In one embodiment, the elongated cylindrical structure 20 has a length-to-diameter ratio of at least 4:1 and possesses a streamlined shape to reduce its drag coefficient and minimize the fluid pressure drop across its length. Devices having a cylindrical structure with a length-to-diameter ratio greater than about 4:1 exhibit substantially better performance characteristics (e.g., linearity) than those having a length-to-diameter of less than about 4:1.

The gap between the entire length of streamlined cylindrical structure 20 and the inner wall of the sensor housing is generally referred to herein as the “annular region” and would generally comprise not less than about 20% nor more than about 50% of the open inlet area of the sensor subassembly. Devices having a cylindrical structure with a length-to-diameter ratio of at least 4:1 and occupying 50-80% of the open inlet area exhibit substantially better performance characteristics than those with cylindrical structures configured outside the ranges. In another embodiment, the cylindrical structure has a length-to-diameter ratio of at least 3:1. Ends 22 and 24 may be streamlined (e.g., tapered, hemispherically tipped, or rounded) and may not necessarily have the same shape. The elongated cylindrical structure 20 is fixedly attached within the sensor housing by support 15 (but may include a plurality of supports to insure alignment and centering of the elongated structure along the longitudinal axis of the housing and conduit). The elongated cylindrical structure 20 is dimensioned appropriately to accommodate the interior dimensions of the housing and the particular nature of the fluids, flow rates and densities to be measured.

Two pressure measurements are obtained anywhere in the annular region between the elongated cylindrical structure and the interior wall of the cylindrical sensor housing.

A first dynamic pressure measurement P₁ is obtained from an upstream-facing pressure port 30 and a second dynamic pressure measurement P₂ is obtained from an adjacent, but oppositely directed (i.e., downstream-facing) pressure port 40. Thus, two dynamic pressure signals so obtained allow their combination to simultaneously determine fluid mass flow rate Q_{M}, volumetric flow rate Q_{V} and density of the fluid ρ (if it is a gas) passing through the apparatus. Fluid temperature is monitored by temperature sensor 48. Additionally, dynamic pressure ports for P₁ and P₂ can be incorporated into subassembly 41 allowing for straightforward assembly, removal and replacement of the subassembly if desired. To simplify design, the temperature and pressure sensors may be combined into one removable subassembly or module. The following relationships and definitions apply to the present invention:

P₀=static pressure near the location of the dynamic pressure ports (1)

P₁=fluid dynamic pressure facing up-stream (2)

P₂=fluid dynamic pressure facing down-stream (3)

V_{C}=average fluid velocity in conduit (4)

A_{C}=conduit cross-sectional area (5)

Q_{V}=fluid volumetric flow rate=V_{C}A_{C} (6)

Q_{M}=fluid mass flow rate=ρQ_{V}=ρV_{C}A_{C}. (7)

If the fluid flowing through the sensor is a liquid,

ρ_{L}=liquid density=ρ_{L}(T), (8)

where ρ_{L}(T) is the liquid density as a function of absolute fluid temperature T. If the fluid is a gas, the density of the gas, ρ_{G} can be expressed as

ρ_{G}=n/v=P₀/(RTZ), (9)

with gas density ρ_{G} varying according to the General Gas Law as represented by (10) through (14) below.

Pv=nRTZ, (10)

where n is proportional to mass of the gas contained in volume v

v=volume occupied by gas (11)

R=Universal Gas Constant (12)

T=absolute temperature of gas (13)

Z=a gas compressibility factor(Z=1 for ideal gases) (14)

As fluid flows through a conduit of cross-sectional area A_{C} with average velocity V_{C}, the cylindrical structure directs flow into the annular region of area A with average velocity, V, given by

V=V_{C}(A_{C}/A), (15a)

since AV=A_{C}V_{C} (neglecting fluid compressibility). When fluid is flowing, the upstream dynamic pressure P₁ measured at 30 is expressed as

P₁=½ρV²+P₀ (16)

The downstream-facing dynamic pressure P₂ measured at 40 is expressed as

P₂=−½ρV²+P₀, (17)

where P₀ is the static pressure of the fluid at the location where the two dynamic pressures are measured. Note that if P₂ is subtracted from P₁ (e.g., as when employing a differential pressure transducer) one obtains

P₁−P₂=ρV². (18)

If P₁ is added to P₂ one obtains

P₁+P₂=2P₀=2ZRTρ(gases), (19)

P₁+P₂=2P₀(liquids). (20)

For gases, if (18) is divided by (19) one obtains

(P₁−P₂)/(P₁+P₂)=V²/2ZRT(gases). (21)

The average fluid velocity V is obtained from (21) yielding

V={2ZRT(P₁−P₂)/(P₁+P₂)}^{1/2}(gases). (22)

For gases, the volumetric flow rate Q_{vG} can be expressed from (6) above as

Q_{VG}=AV=A{2ZRT(P₁−P₂)/(P₁+P₂)}^{1/2}. (24)

Using (7) above, the associated gas mass flow rate Q_{MG} is given by

Q_{MG}=ρ_{G}AV=A{(P₁−P₂)(P₁+P₂)/2ZRT}^{1/2}. (25)

Gas density ρ_{G} can be expressed as

ρG=(P₁+P₂)/(2ZRT). (26)

Thus for gases, mass flow rate Q_{MG}, volumetric flow rate Q_{VG} and density ρ_{G} can be determined concurrently by combining a fluid temperature measurement, T, with two dynamic pressure readings P₁ and P₂ as expressed above in equations (24) through (26).

Because mass flow rate Q_{MG}, volumetric flow rate Q_{VG} and density ρ_{G} are determined simultaneously from the same pressure sensing means positioned at substantially the same physical location, their measured values are self-consistent in contrast to measuring gas density using a separate pressure sensor or transducer located elsewhere in the sensor or in the adjoining conduit. Likewise for liquids,

P₁−P₂=ρ_{L}V². (27)

The average liquid velocity, V, can be expressed as

V={(P₁−P₂)/ρ_{L}(T)}^{1/2}. (28)

Thus the liquid volumetric flow rate, Q_{VL}, is given by

Q_{VL}=AV=A{(P₁−P₂)/ρ_{L}(T)}^{1/2}. (29)

The corresponding liquid mass flow rate, Q_{ML}, is expressed as

Q_{ML}=ρ_{L}AV=A{(P₁−P₂)ρ_{L}(T)}^{1/2}. (30)

Where ρ_{L}(T) represents the liquid density as a function of fluid temperature T as expressed by

ρ_{L}(T)=ρ_{L}(T_{R})[1+α(T,T_{R})], (31)

where α=α(T,T_{R}) represents a general functional relationship of liquid density versus temperature T relative to that at reference temperature, T_{R}, and ρ_{L}(T_{R}) is the known liquid density at a reference temperature T_{R}, at T=T_{R}, α(T,T_{R})=0.

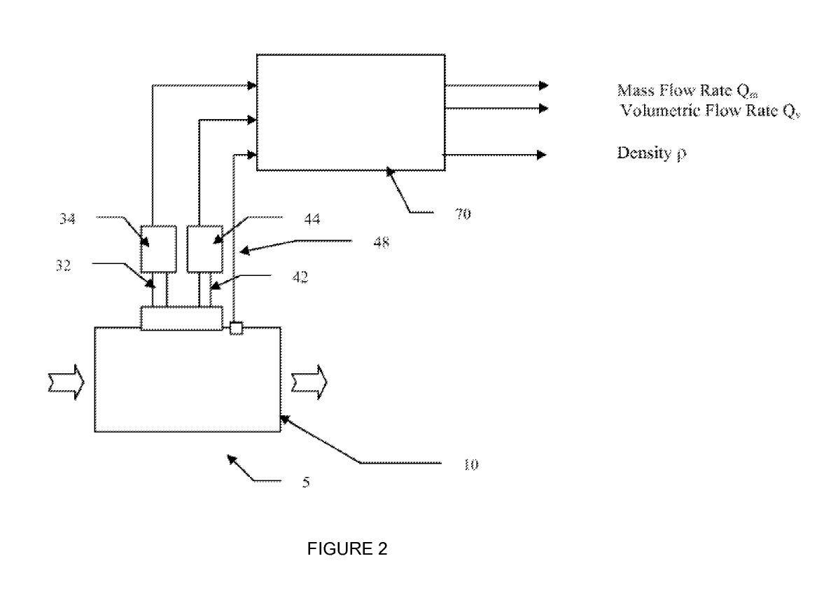

With reference to FIG. 2, external pressure ports 32 and 42 respectively communicate the upstream and downstream dynamic fluid pressures to pressure sensing means 34 and 44. Electronic output signals from pressure sensing means 34 and 44 representative of dynamic pressures P₁ and P₂ are input to processing means 70 together with fluid temperature, T, sensed by temperature sensor 48. The outputs of processing means 70 provide electronic output signals and output indications representative of fluid mass flow rate, fluid volumetric flow rate and fluid density in accordance with equations (24), (25) and (26) when measuring gases and in accordance with equations (29), (30) and (31) when measuring liquids. FIGS. 3 to 11 illustrate additional embodiments. In FIG. 3, support structure or “post” 50 includes built-in dynamic pressure sensing ports 30 and 40 thereby eliminating the need for a separate support as illustrated by 15 in the previous embodiment (FIG. 1). This particular embodiment includes fabricating (via CNC machining, investment casting or injection molding) the entire sensor subassembly from one piece of material (e.g., metal or plastic) comprising the elongated cylindrical structure 20, post 50 and pressure sensing passageways 30 and 40. The processing of the pressure and temperature signals and computation of mass flow rate, volumetric flow rate and density (schematically illustrated in FIG. 2) is consistent with that for FIG. 1.

It is understood that other pressure sensing arrangements can be applied to the present invention without departing from the teachings of the present invention. For example, differential pressure sensing means could also be employed to measure P₁-P₂ directly using two pressure sensing ports like 30 and 40, but without measuring either pressure individually in which case a third static pressure sensing port would also be required to measure static pressure P₀. Alternatively, dynamic pressure measurements P₁ and P₂ (or P₀) could also be performed with each pressure sensing measurement obtained at a different physical location along the length and/or circumference of the annular region. The average fluid velocity is higher in the annular region resulting from that region's smaller area compared to that at the entrance to the flow sensor. Increased fluid velocity increases dynamic pressure quadratically thereby producing larger dynamic pressure signal levels. For example, doubling the fluid velocity quadruples the signal. Thus, measuring dynamic pressure in this annular region of comparatively higher fluid velocity enhances measurement sensitivity and the ability to measure increasingly lower flow rates. In the present invention, only one dynamic pressure measurement is required which is responsive to the fluid's kinetic energy in the annular region, whereas the '957 patent requires two dynamic pressure sensors that measure the pressure drop across the flow-body structure of the '957 patent.

In the present invention, the elongated cylindrical structure alters and “conditions” the fluid flow as it is channeled into and through the annular region. Thus, upstream flow disturbances that could otherwise perturb a dynamic pressure measurement if performed at the tip of the cylindrical structure and adversely influence flow measurement accuracy are avoided in the present invention. Larger dynamic pressure signal levels at the point of measurement and reduced immunity to upstream flow disturbances are significant benefits of performing dynamic pressure measurements within in the annular region in addition to providing the mirror-image symmetrical pressure sensing arrangement discussed in the following paragraph.

With reference to FIG. 1, if the streamline-shaped ends 22 and 24 have identical shape and if the upstream and downstream pressure sensing ports 30 and 40 are substantially centered about the lateral mid-point of the cylindrical structure thereby creating substantial structural symmetry, then the sensor has substantial symmetry with respect to measuring fluid flow in either flow direction. Accordingly, the flow sensor structure will present substantially equal impedance to fluid flow in either the “forward” or “reverse” direction thereby simplifying calibration and enhancing measurement accuracy for measuring bi-directional flows. These considerations are of particular importance for pulmonary applications where a sensor must present substantially equal impedance to air flow in both flow directions, otherwise unequal impedances to flow direction will skew the data complicating analysis of results.

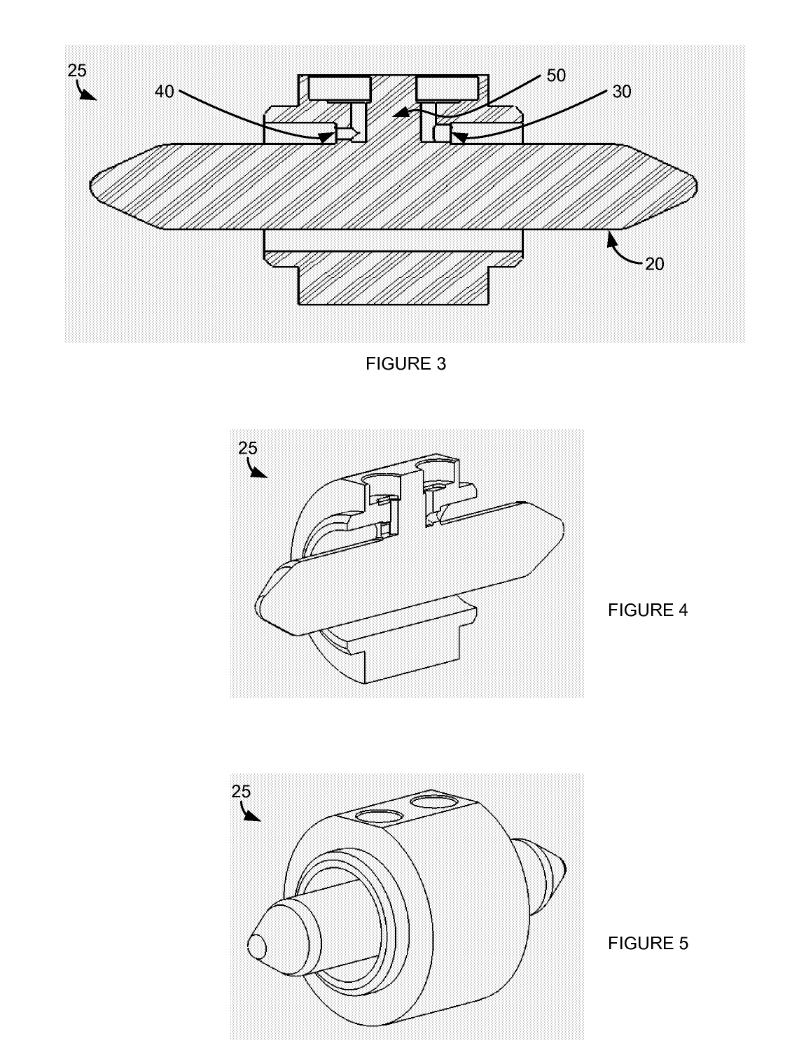

FIG. 3 illustrates an embodiment of the sensor shown in FIG. 1 wherein support 15 is eliminated and post 50, pressure passageways 30, 40 and elongated cylindrical structure 20 comprise one-piece. This type of construction avoids gaps and crevices that would otherwise be present if sensor subassembly 25 were fabricated from multiple components and reduces manufacturing cost. FIGS. 4 and 5 respectively illustrate cross-sectional and isometric views of the one-piece sensor subassembly 25.

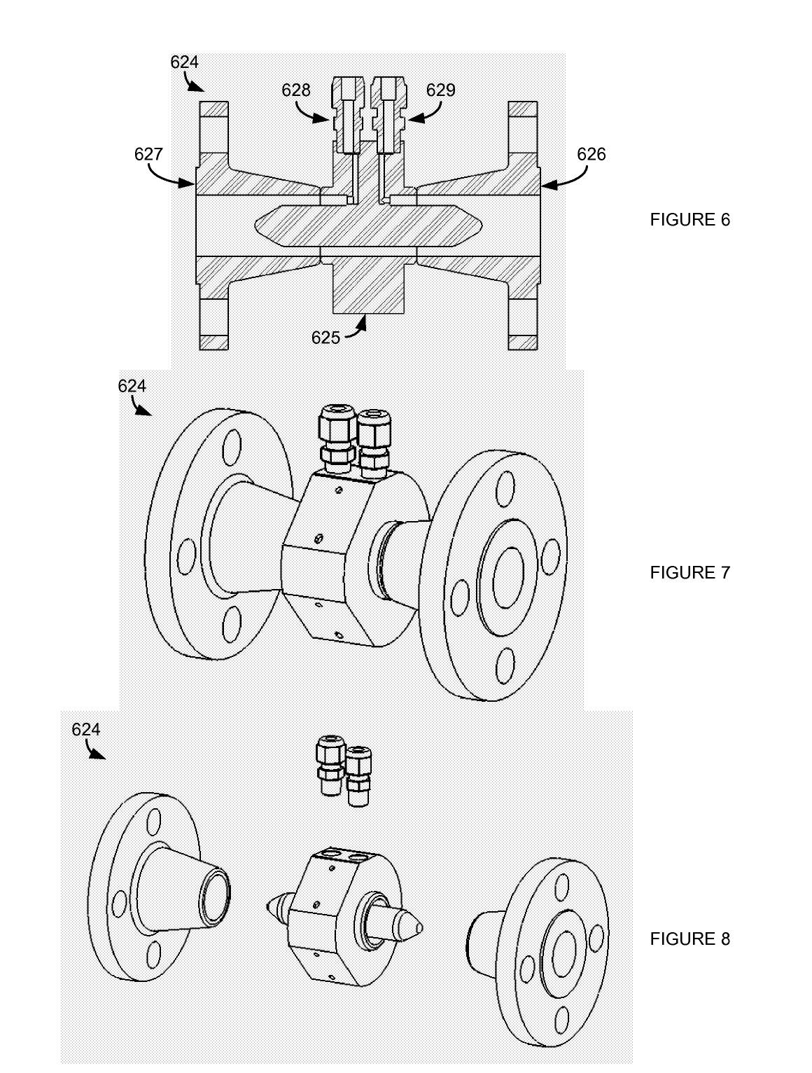

FIG. 6 depicts a cross-sectional view of sensor sub-assembly 25 incorporated into an assembled flowmeter assembly 624 including flange end-connections 626 and 627 (for connection to the adjoining conduit) and dynamic pressure fittings 628 and 629 (for connection to a suitable pressure transducer(s)).

FIGS. 7 and 8 respectively illustrate an assembled flowmeter 624 comprised of one-piece sensor subassembly 25 joined (e.g., welded) to end connections 626, 627 and pressure fittings 628, 629.

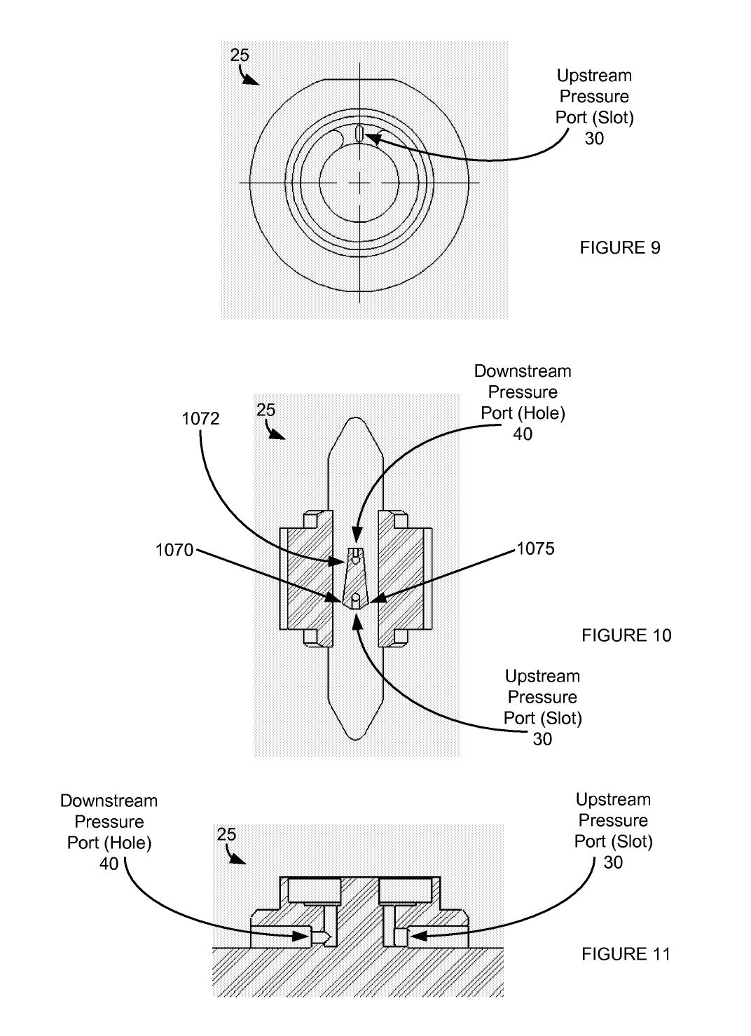

As fluid is directed into the annular region it necessarily exhibits a flow velocity profile between the elongated cylindrical structure and the interior wall of the sensor. This flow velocity profile may be non-uniform (e.g., asymmetric or skewed). Accordingly the circular dynamic pressure ports 30 and 40 depicted in FIG. 1 may not necessarily sample dynamic pressures representative of the fluid flowing through the annular region. Accordingly, one embodiment of the present invention includes a slot 30 in the upstream-facing port spanning substantially the entire width of the annular gap as depicted in FIG. 9. Employing a slotted-port rather than a small circular port in the upstream facing dynamic pressure measurement results in larger dynamic pressure signal levels and improved linearity in response.

If post 50 in FIG. 3 has a circular or rectangular cross-section it is possible the vortices shed from such a structure can produce small signals in the downstream dynamic pressure port that could interfere with signals associated with fluid flow and effectively degrade the sensor's signal-to-noise ratio. This effect can be substantially reduced by incorporating post 1072 as depicted in FIG. 10 having a non-rectangular (and non-circular) cross-section. This shape allows vortices shed from the upstream corners 1070 and 1075 of post 1072 in FIG. 10 to be effectively swept downstream with substantially reduced influence on the downstream dynamic pressure measurement at port 40.

FIG. 11 depicts a cross-sectional view illustrating the upstream facing slot 30 and downstream facing circular hole 40 within post 1072 of FIGS. 10 and 11.

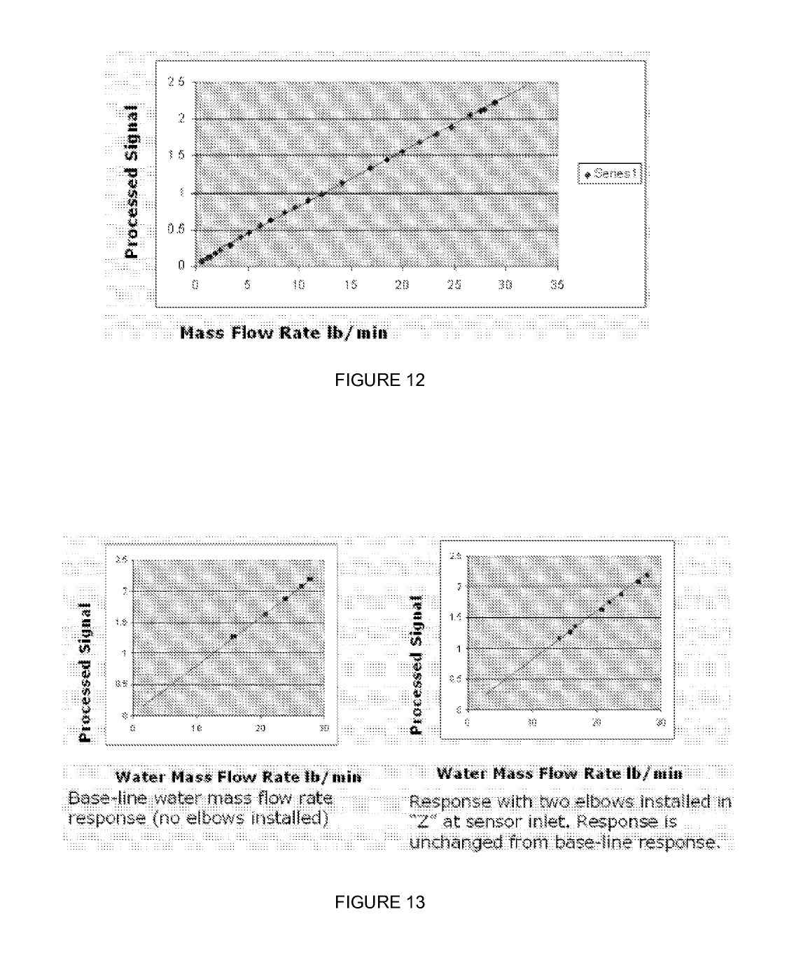

FIG. 12 illustrates flow rate test data on water obtained with a sensor similar in design to that schematically represented in FIG. 1. The sensor employs an elongated cylindrical structure of 0.36-inch O.D. and 0.75-inch length with “bullet”-shaped ends contained within a sensor housing of 0.5-inch I.D. The sensor exhibits an observed flow rate measurement range of about 47:1. Significantly, the tests spanned flow rates with the flow regime varying from laminar (Re=464 at lowest flow rate) through the transition region and into the turbulent regime (Re=21,900 at maximum flow rate). The lack of any observed instability illustrates the sensor's response to flow rate is substantially independent of flow regime in contrast to many other types of flowmeters (e.g., differential pressure, ultrasonic, turbine and vortex shedding).

FIG. 13 illustrates test data obtained using the same sensor as tested in FIG. 12 and illustrates the sensor's immunity to non-uniformities in flow velocity profile. The sensor's response was measured with water at several flow rates to establish a “base-line” response. Then two elbows were installed at the inlet to the sensor, which are known to introduce a skewed, non-uniform flow velocity profile across the inlet to the sensor. Yet the sensor's response observed with two elbows installed at the sensor inlet plotted together with the “base-line” data (i.e., no elbows) indicates no appreciable change in sensor response.

Consequently, the elongated cylindrical structure alters or transforms the fluid flow in such a way that, the resulting flow rate measurements are substantially independent of flow regime and immune to variations and disturbances in flow velocity profile thereby offering a substantial improvement over conventional flow rate measurement devices.

Yet another embodiment of the present invention is based on applying the improved measurement method of the present invention to the apparatus described in the '957 patent.

The '957 patent teaches a mass flow measurement by subtracting two dynamic pressure measurements, which however differ substantially from those of the present invention.

As set forth in the Background of the Invention section, in FIG. 4 of the '957 patent, a first dynamic pressure measurement P₁ is obtained at the apex of a conically-shaped end-piece; a second dynamic pressure measurement P₂ is obtained at a different location from a pressure port located within the “cylindrical portion” of the body. According to the '957 patent, solely the difference between these two dynamic pressure signals determines fluid mass flow rate. In contrast to the present invention, the '957 patent teaches measuring a different dynamic pressure differential and teaches a different relationship between fluid mass flow and the measured pressure difference. The '957 patent teaches that the dynamic pressure difference measured across a “flow body” (from cone apex to “cylindrical portion”) is sufficient to determine mass flow rate. In contrast to the '957 patent, the present invention employs two pressure measurements performed at substantially the same physical location within the annular region. Yet another important distinction between the '957 patent and the present invention is that the flow measurement described in the '957 patent is not density independent, which is a fundamental requirement for any fluid mass flow sensor. For example, FIG. 6 of the '957 patent illustrates that the response of the '957 flow sensor produces distinctly different responses to gases of different density (i.e., air and Argon). However, if the difference between the two pressure signals described in the '957 patent were sufficient to determine mass flow rate, then the responses would be the same for the two gases. By contrast, the mass flow measurement method of the present invention inherently accounts for fluid density. As a result, the teaching of the '957 patent that pressure differential alone determines mass flow rate differs from that of the present invention.

The '957 patent further states that “Dynamic pressure measurements, P₁ and P₂, result from the stable and smooth vortex trail generated by flow body 42” asserting that such pressure signals are produced by prominent “vortex generated differential pressures”. By contrast, the operation of the present invention involves no vortices, but rather relies solely on measuring the dynamic pressure resulting from the kinetic energy of the fluid flowing in the annular region where there is no vortex trail caused by the “flow body”. Furthermore, because the elongated cylindrical structure of the present invention is necessarily of streamlined-shape, it cannot produce vortices.

However, despite these significant differences between the '957 patent and the present invention, a device such as that described in the '957 patent (e.g., FIG. 4, 12, 16 or 19) could benefit from the improved flow measurement method described herein. In particular, the signal processing method schematically depicted in FIG. 2 of the present invention, which simultaneously determines fluid mass flow rate, volumetric flow rate and gas density, could be applied beneficially to the type of flow body device described in the '957 patent, though not with the same accuracy because the device in the '957 patent would exhibit a hydrostatic pressure drop between the two pressure sensing locations that varies with flow rate because of the cylindrical structure interposed between that invention's two pressure sensing locations. Such is not the case with the present invention.

In contrast with other flow measurement devices employing either a static or dynamic differential pressure measurement across a flow obstruction or a flow constriction (including that described in the '957 patent), the dynamic pressure measurements of the present invention are performed at substantially the same location but with opposite upstream-downstream orientation in one embodiment (e.g., FIGS. 1 and 3-11).

Unlike the flow body of the '957 patent, the elongated cylindrical structure of the present invention 20 has no channels or passageways that could clog or otherwise become contaminated (a requirement for sanitary service or medical applications) and accordingly is less expensive to fabricate.

An embodiment of the present invention (as schematically depicted in FIG. 1) uses a pressure sensor assembly 41 akin to that of a Pitot-tube allowing for straightforward assembly, removal and replacement for cleaning if required whereas the entire sensor of the '957 patent requires disconnection and removal from the attached conduit for cleaning.

The foregoing detailed description of the invention has been presented for purposes of illustration and description. It is not intended to be exhaustive or to limit the invention to the precise form disclosed. Many modifications and variations are possible in light of the above teaching. The described embodiments were chosen in order to best explain the principles of the invention and its practical application to thereby enable others skilled in the art to best utilize the invention in various embodiments and with various modifications as are suited to the particular use contemplated.

I claim:

1. A system for measuring fluid flow through a conduit having a central axis, the system comprising:
a first pressure responsive element for measuring dynamic and static pressure, the first pressure responsive element having a first opening at a fixed radial position relative to the central axis, the first opening facing a direction opposite to a direction of fluid flow through the conduit;
a second pressure responsive element for measuring one of dynamic and static pressure, wherein the first and second pressure responsive elements allowing the determination of each of mass flow rate, volumetric flow rate and a density of the fluid; and
a structure supported in a fixed position circumjacent about the central axis, the structure having first and second streamlined ending sections and a cylindrically symmetric section between the first and second streamlined ending sections, the streamlined ending and cylindrically symmetric sections being concentric about the central axis and reducing a cross-sectional area of the conduit in the area of the structure to between 20% and 50% of an open inlet area of the conduit.

2. The system of claim 1, wherein a length of the structure measured along the direction of the fluid flowing through the conduit and a diameter of the cylindrically symmetric section has a length-to-diameter ratio of at least 3:1.

3. The system of claim 1, wherein the structure is supported by a post connecting the structure with the conduit, wherein both the first and second pressure responsive elements locate on the post, and wherein the system comprises a one-piece construction that includes the conduit, the post, and the structure.

4. The system of claim 1, wherein the first opening comprises a slot spanning substantially an entire width of an annular gap formed between the structure and the conduit.

5. The system of claim 1, wherein the structure is supported by a post connecting the structure with the conduit, and the post has a non-rectangular cross-section with one or more corners positioned to enhance a signal-to-noise ratio of the second pressure responsive element.

6. The system of claim 1, wherein the second pressure responsive element is capable of measuring static pressure and has an opening facing a direction substantially perpendicular to the direction of fluid flow through the conduit.

7. The system of claim 1, wherein the second pressure responsive element is capable of measuring dynamic pressure and has an opening facing a direction substantially opposite to the direction of the first opening.

8. The system of claim 1, wherein the first and second streamlined ending sections have a same tapering shape.

9. The system of claim 1, wherein the first and second streamlined ending sections have different shapes.

10. The system of claim 1, wherein a plane through a cross-section of the structure midway between the first and second streamlined ending sections and perpendicular to the direction of the fluid flow defines first and second halves of the structure, the first half having a same shape as the second half.

11. The system of claim 1, wherein a plane through a cross-section of the structure midway between the first and second streamlined ending sections and perpendicular to the direction of the fluid flow defines first and second halves of the structure, the first half having a different shape than the second half.

12. The system of claim 1, wherein the structure provides a substantially constant fluid flow velocity across a cross-sectional area of the conduit including the structure.

13. A method of measuring fluid flow through a conduit having a central axis, the method comprising the steps of:
(a) decreasing a cross-sectional area across which fluid flows in a section of the conduit to between 20% and 50% of an open inlet area of the conduit by positioning a structure within the conduit, the structure having first and second streamlined ending sections and a cylindrically symmetric section between the first and second streamlined ending sections, the streamlined ending and cylindrically symmetric sections being concentric about the central axis;
(b) measuring dynamic and static pressure with a first pressure responsive element having a first opening at a fixed radial position relative to the central axis, the first opening facing a direction opposite to a direction of fluid flow through the conduit;
(c) measuring one of dynamic and static pressure with second pressure responsive element; and
(d) determining the fluid flow of the fluid through the conduit based on the measurements taken in said steps (b) and (c).

14. The method of claim 13, wherein a length of the structure measured along the direction of the fluid flowing through the conduit and a diameter of the cylindrically symmetric section has a length-to-diameter ratio of at least 3:1.

15. The method of claim 13, wherein the structure is supported by a post connecting the structure with the conduit, wherein both the first and second pressure responsive elements locate on the post, and wherein the conduit, the post, and the structure are parts of a one-piece construction.

16. The method of claim 13, wherein the first opening comprises a slot spanning substantially an entire width of an annular gap formed between the structure and the conduit.

17. The method of claim 13, wherein the structure is supported by a post connecting the structure with the conduit, and the post has a non-rectangular cross-section with one or more corners positioned to enhance a signal-to-noise ratio of the second pressure responsive element.

18. The method of claim 13, wherein the second pressure responsive element is capable of measuring static pressure and has an opening facing a direction substantially perpendicular to the direction of fluid flow through the conduit.

19. The method of claim 13, wherein the second pressure responsive element is capable of measuring dynamic pressure and has an opening facing a direction substantially opposite to the direction of the first opening.

20. A system for measuring fluid flow through a conduit having a central axis, the system comprising:
a first pressure responsive element for measuring dynamic and static pressure, the first pressure responsive element having a first opening at a fixed radial position relative to the central axis, the first opening facing a direction opposite to a direction of fluid flow through the conduit;
a second pressure responsive element for measuring one of dynamic and static pressure, wherein the first and second pressure responsive elements allowing the determination of each of mass flow rate, volumetric flow rate and a density of the fluid; and
a structure supported in a fixed position circumjacent about the central axis, the structure having first and second streamlined ending sections and a cylindrically symmetric section between the first and second streamlined ending sections, the streamlined ending and cylindrically symmetric sections being concentric about the central axis, wherein a length of the structure measured along the direction of the fluid flowing through the conduit and a diameter of the cylindrically symmetric section has a length-to-diameter ratio of at least 3:1.
